(19) United States
(12) Patent Application Publication
(10) Pub. No.: US 2010/0259211 A1
(43) Pub. Date: Oct. 14, 2010

(54) Recharge battery safely chargeable with solar energy

(76) Inventor: Jen Yen Yen, Changhua Hsien (TW)

Correspondence Address: CHARLES E. BAXLEY, ESQUIRE, 90 JOHN STREET, SUITE 309, NEW YORK, NY, 10038, US

(21) Appl. No.: 12/384,767

(22) Filed: Apr. 8, 2009

(51) Int. Cl. H02J 7/00

(52) U.S. Cl. 320/101

(57) ABSTRACT

A recharge battery device includes a solar charge coupled to a alkaline recharge battery for supplying a solar energy to the alkaline recharge battery, an inner recharge battery coupled to the alkaline recharge battery, a safeguard and a voltage detector coupled to the alkaline recharge battery for actuating the safeguard to cut off the energy to the alkaline recharge battery when the alkaline recharge battery may not be suitably recharged or charged, or when the alkaline recharge battery is overflow or overcharged, or when too much energy is supplied to the alkaline recharge battery, and for preventing the alkaline recharge battery from being overcharged or damaged.

### BACKGROUND OF THE INVENTION

1. Field of the Invention

The present invention relates to a recharge battery system or assembly, and more particularly to a recharge battery assembly including a safety or warning device for generating a warning signal when the recharge battery may not be suitably recharged or charged and for providing the damage information of the recharge battery to the user and for allowing the recharge battery to be suitably changed by the user.

2. Description of the Prior-Art

Typical solar energy collecting devices or facilities comprise one or more recharge batteries coupled to one or more solar panels for receiving and collecting the solar energy from the solar panels and for supplying the collected solar energy to charge or to energize various electric loads.

However, no safety or warning devices have been provided and coupled to the recharge batteries of the typical solar energy collecting devices or facilities, and the recharge batteries may have a good chance to be overcharged, or a collected solar energy may overflow in the recharge batteries, such that the recharge batteries may have a good chance to be damaged or even exploded inadvertently.

The present invention has arisen to mitigate and/or obviate the afore-described disadvantages of the conventional recharge battery devices or facilities.

### SUMMARY OF THE INVENTION

The primary objective of the present invention is to provide a recharge battery assembly including a safety or warning device for generating a warning signal when the recharge battery may not be suitably recharged or charged and for providing the damage information of the recharge battery to the user and for allowing the recharge battery to be suitably changed by the user.

In accordance with one aspect of the invention, there is provided a recharge battery assembly comprising a first recharge battery, a solar charge coupled to the first recharge battery for receiving a solar energy and for supplying the solar energy to the first recharge battery, a second recharge battery coupled to the first recharge battery, a safeguard and a voltage detector coupled to the first recharge battery, the voltage detector including an integrated circuit (IC) and two resistors coupled to the integrated circuit (IC), and the safeguard including a transistor coupled to the integrated circuit (IC) for actuating the transistor of the safeguard to cut off the energy to the first recharge battery, a reference regulator and a voltage comparator coupled to the first recharge battery and the second recharge battery to detect a voltage level in the first recharge battery, and a warning device coupled to the voltage comparator for being actuated to generate a warning signal by the voltage comparator when the recharge battery may not be suitably recharged or charged, or when the alkaline recharge battery is overflow or overcharged, or when too much energy is supplied to the alkaline recharge battery, and for preventing the alkaline recharge battery from being overcharged or damaged, and for allowing the recharge battery to be suitably changed with the new ones or the new batteries by the user.

The solar charge includes a diode coupled between the solar charge and the first recharge battery for directing the solar energy to flow only from the solar charge to the first recharge battery and for preventing the solar energy from flowing backward from the first recharge battery to the solar charge.

The solar charge is selected from a single crystal, a multi-crystal, or a non-crystal solar charge. The first recharge battery is preferably an alkaline battery.

A load may further be provided and coupled to the second recharge battery for receiving the energy from the first recharge battery and the second recharge battery and for allowing the load to be energized by the first recharge battery and the second recharge battery. The load may be selected from an MP3, a radio, or a light device.

The warning device includes a buzzer, a light device, or the like. The reference regulator includes a diode coupled to a resistor at one side and grounded at the other side.

An energy coupling device may further be provided and coupled to the first recharge battery for guiding or directing an electric energy to the first recharge battery. The energy coupling device is selected from a transformer, a car adaptor, or a universal serial bus coupler.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a plan schematic view illustrating the electric circuit of a recharge battery assembly in accordance with the present invention;

FIG. 2 is a block diagram of the recharge battery assembly;

FIG. 3 is another block diagram of the recharge battery assembly, similar to FIG. 2;

FIG. 4 is a further block diagram of the recharge battery assembly, similar to FIGS. 2 and 3;

FIG. 5 is a plan schematic view illustrating a recharge battery of the recharge battery assembly; and

FIGS. 6, 7 are plan schematic views similar to FIG. 5, illustrating the operation of the recharge battery assembly.

### DETAILED DESCRIPTION OF THE PREFERRED EMBODIMENT

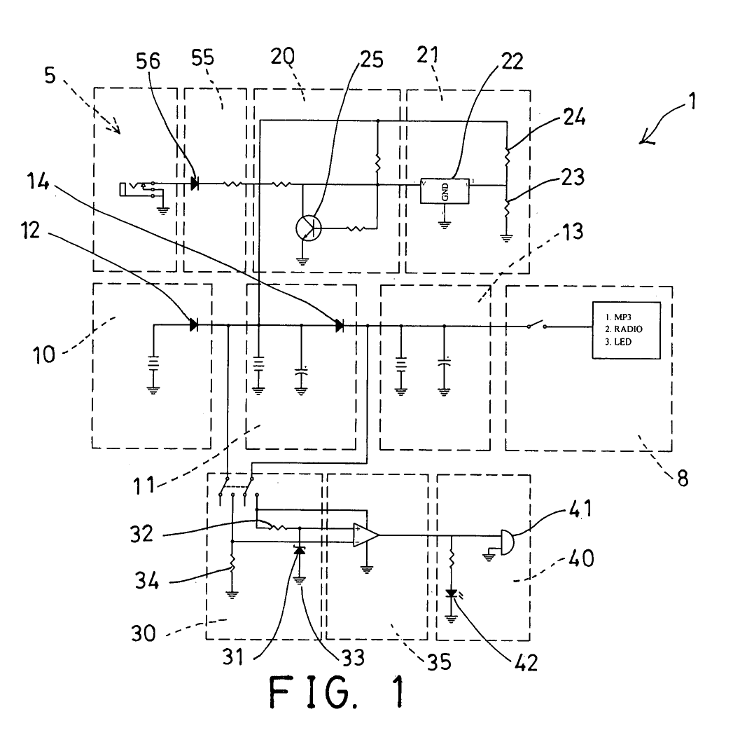

Referring to the drawings, and initially to FIG. 1, a recharge battery assembly 1 in accordance with the present invention comprises a solar energy collecting panel or device or a solar charge 10 for collecting the solar energy, an alkaline or first recharge battery 11 coupled to the solar charge 10 for receiving the solar energy from the solar charge 10 and for allowing the recharge battery to be suitably charged by the solar charge 10, a diode 12 disposed or coupled between the solar charge 10 and the alkaline or first recharge battery 11 for directing or guiding the solar energy to flow only from the solar charge 10 to the alkaline or first recharge battery 11 and for preventing the solar energy from flowing backward from the alkaline or first recharge battery 11 to the solar charge 10. The solar charge 10 may either be a single crystal, a multi-crystal, or a non-crystal solar charge 10.

Another or an internal or second recharge battery 13 is coupled to the alkaline or first recharge battery 11, and another diode 14 is disposed or coupled between the alkaline or first recharge battery 11 and the second recharge battery 13 for directing or guiding the solar energy to flow only from the first recharge battery 11 to the second recharge battery 13 and for preventing the solar energy from flowing backward from the second recharge battery 13 to the first recharge battery 11. A load 8, such as a music player, a moving pictures experts group (MPEG-1 Audio Layer 3 or MP3), a radio, a light emitting diode or light device, or the like is coupled to the second recharge battery 13 for receiving the energy from the first recharge battery 11 and/or the second recharge battery 13 and for allowing the load 8 to be energized by the first recharge battery 11 and/or the second recharge battery 13.

A safeguard 20 and a voltage detector 21 are coupled to the first recharge battery 11 and/or the second recharge battery 13, and the voltage detector 21 includes a processor unit or integrated circuit (IC) 22, and two resistors 22, 23 coupled to the integrated circuit (IC) 22, and the safeguard 20 includes a transistor 25 coupled to the integrated circuit (IC) 22, in which the integrated circuit (IC) 22 will actuate the transistor 25 of the safeguard 20 to cut off the supplying of the electric energy to the first recharge battery 11 and to prevent the first recharge battery 11 and/or the second recharge battery 13 from being overcharged and thus for protecting the first recharge battery 11 and/or the second recharge battery 13 from being spoiled or damaged by the overcharged electric energy inadvertently.

A reference regulator 30 is coupled to the second recharge battery 13 and includes a further diode, such as a zener diode 31 coupled to a further resistor 32 at one side or at one end and grounded at the other side or end 33, a voltage comparator 35 is coupled to the reference regulator 30 and the first recharge battery 11 for taking the voltage in the diode 31 and/or the resistor 32 and/or the grounded end 33 as a reference voltage or signal, and for comparing with the voltage or signal from the first recharge battery 11 to a still further resistor 34 which is coupled to the diode 31 and the voltage comparator 35. A warning device 40 includes a siren or buzzer 41 and/or a light emitting diode or light device 42 coupled to the voltage comparator 35.

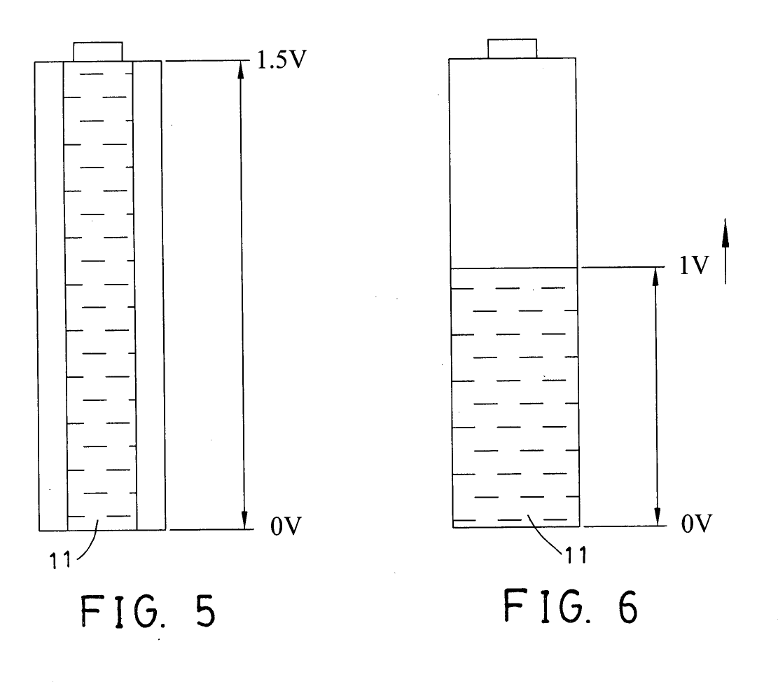

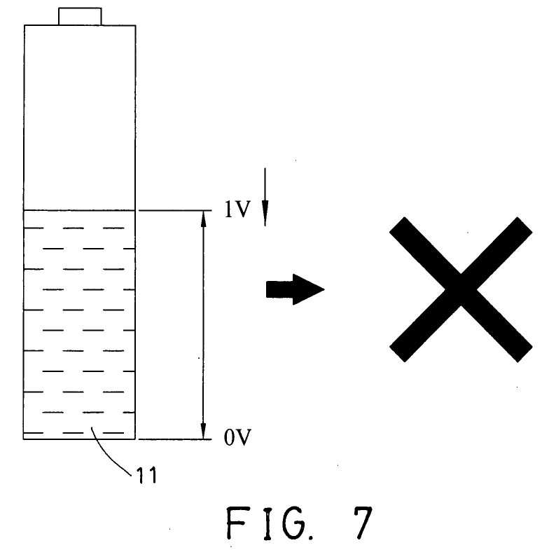

In operation, as shown in FIGS. 5 and 6, when the voltage or the energy in the first recharge battery 11 is above or more than the required basic value or voltage or energy, the voltage comparator 35 will not actuate the warning device 40, and neither of the buzzer 41 nor the light device 42 of the warning device 40 will be energized or actuated. On the contrary, as shown in FIG. 7, when the voltage or the energy in the first recharge battery 11 is lower than the required basic value or voltage or energy, the voltage comparator 35 will actuate either or both of the buzzer 41 and the light device 42 of the warning device 40 to generate a warning signal, such as a warning sound or a warning light when the recharge battery 11 may not be suitably recharged or charged, such that the user may realize that the recharge battery 11 has been damaged or may not be recharged, and such that the recharge battery 11 to be suitably changed or replaced with the new one by the user. The comparator 35 will also actuate the warning device 40 to generate a warning signal when the recharge battery 11 is overflow or overcharged or when too much energy is supplied to the recharge battery 11.

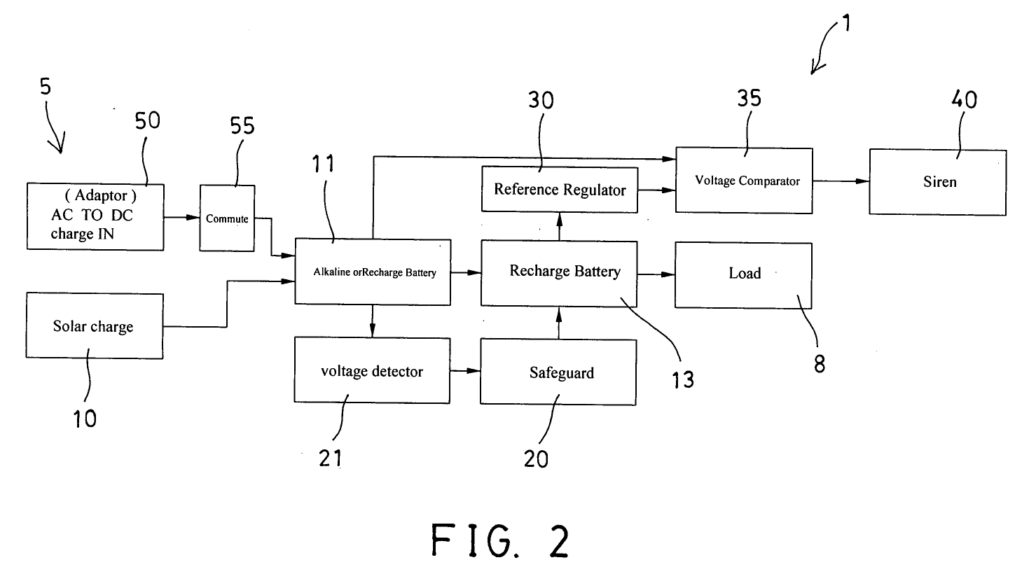

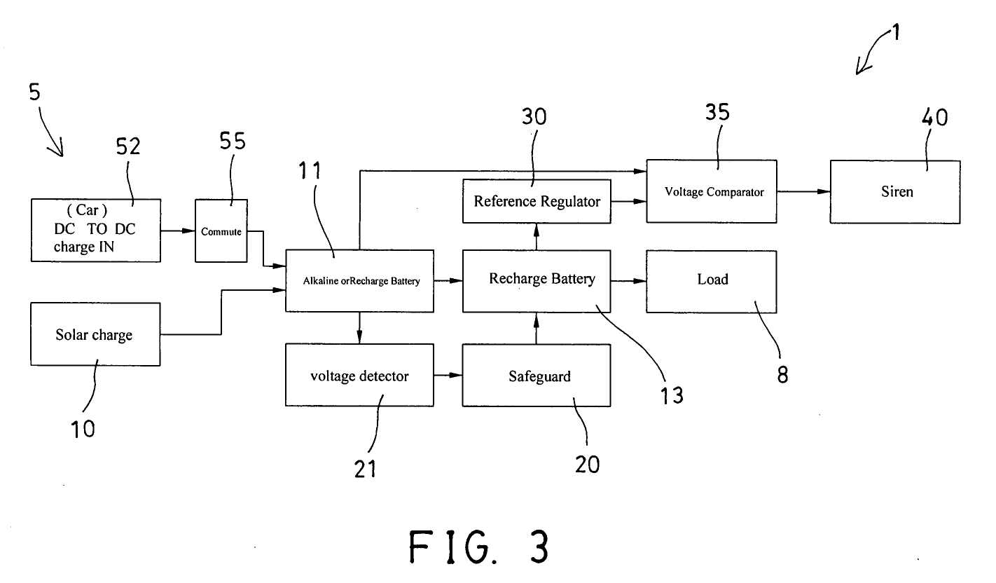

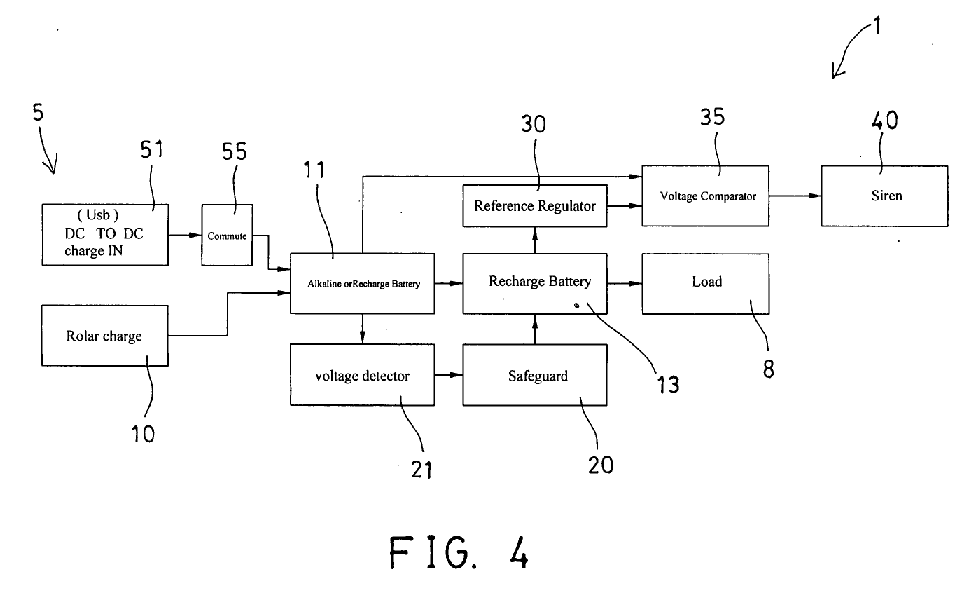

Another energy reservoir or energy coupling device 5, such as an adaptor or transformer 50 (FIG. 2), a car adaptor 52 (FIG. 3) for coupling to the cigarette lighter of the car (not shown), or a universal serial bus (USB) coupler 51 (FIG. 4) may further be provided and coupled to the first recharge battery 11 directly, or indirectly with a rectifying circuit or commute 55, in which the rectifying circuit or commute 55 includes another diode 56 coupled to the coupling device 5 for directing or guiding the electric energy to flow only from the coupling device 5 to the first recharge battery 11 and for preventing the electric energy from flowing backward from the first recharge battery 11 to the coupling device 5 and/or the energy reservoir.

It is to be noted that the voltage comparator 35 may actuate either or both of the buzzer 41 and the light device 42 of the warning device 40 to generate a warning signal when the recharge battery 11 may not be suitably recharged or charged, or when the recharge battery 11 is overflow or overcharged or when too much energy is supplied to the recharge battery 11, and the user may realize that the recharge battery 11 has been damaged or may not be recharged, and such that the recharge battery 11 may be suitablv changed or replaced with the new ones or the new recharge batteries by the user when required.

Accordingly, the recharge battery assembly in accordance with the present invention includes a safety or warning device for generating a warning signal when the recharge battery may not be suitably recharged or charged and for providing the damage information of the recharge battery to the user and for allowing the recharge battery to be suitably changed by the user.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A recharge battery assembly comprising:
a first recharge battery,
a solar charge coupled to the first recharge battery for receiving a solar energy and for supplying the solar energy to said first recharge battery,
a second recharge battery coupled to said first recharge battery,
a safeguard and a voltage detector coupled to said first recharge battery, said voltage detector including an integrated circuit (IC) and two resistors coupled to said integrated circuit (IC), and said safeguard including a transistor coupled to said integrated circuit (IC) for actuating said transistor of said safeguard to cut off the energy to said first recharge battery,
a reference regulator and a voltage comparator coupled to said first recharge battery and the second recharge battery to detect a voltage level in said first recharge battery, and
a warning device coupled to said voltage comparator for being actuated to generate a warning signal by said voltage comparator.

2. The recharge battery assembly as claimed in claim 1, wherein said solar charge includes a diode coupled between said solar charge and said first recharge battery for directing the solar energy to flow only from said solar charge to said first recharge battery and for preventing the solar energy from flowing backward from said first recharge battery to said solar charge.

3. The recharge battery assembly as claimed in claim 1, wherein said solar charge is selected from a single crystal, a multi-crystal, or a non-crystal solar charge.

4. The recharge battery assembly as claimed in claim 1, wherein said first recharge battery is an alkaline battery.

5. The recharge battery assembly as claimed in claim 1, wherein a load is coupled to said second recharge battery for receiving the energy from said first recharge battery and said second recharge battery and for allowing said load to be energized by said first recharge battery and said second recharge battery.

6. The recharge battery assembly as claimed in claim 5, wherein said load is selected from an MP3, a radio, or a light device.

7. The recharge battery assembly as claimed in claim 1, wherein said warning device includes a buzzer.

8. The recharge battery assembly as claimed in claim 1, wherein said warning device includes a light device.

9. The recharge battery assembly as claimed in claim 1, wherein said reference regulator includes a diode coupled to a resistor at one side and grounded at the other side.

10. The recharge battery assembly as claimed in claim 1, wherein an energy coupling device is coupled to said first recharge battery for directing an electric energy to said first recharge battery.

11. The recharge battery assembly as claimed in claim 10, wherein said energy coupling device is selected from a transformer, a car adaptor, or a universal serial bus coupler.
